(19) United States
(12) Patent Application Publication
(10) Pub. No.: US 2011/0076640 A1
(43) Pub. Date: Mar. 31, 2011

(54) ORALLY IMPLANTABLE INTRAOSSEOUS PORT

(76) Inventor: Allan C. Jones, Hermosa Beach, CA (US)

(21) Appl. No.: 12/737,030

(22) PCT Filed: Jun. 3, 2009
(86) PCT No.: PCT/US2009/003370

§ 371 Date: Dec. 2, 2010

Related U.S. Application Data
(60) Provisional application No. 61/130,968, filed on Jun. 5, 2008.

(51) Int. Cl. A61C 19/04; A61C 8/00

(52) U.S. Cl. 433/89; 433/80; 433/215

(57) ABSTRACT

An apparatus for intrasosseous injection of medication to the medullary cavity of a jawbone and for the extraction of medullary bone contents is disclosed. It comprises an implant housing component, a drill bit component and a seal plug component. The implant housing component is implanted into the cortical bone of the mandible. The drill bit component produces a hole within the mandible that initiates the implanting of the implant housing component. The seal plug component that is removably attached to the distal end of the implant housing component allows for repeated access of a hypodermic needle into the mandible.

### CROSS-REFERENCE TO RELATED APPLICATION

This application is a continuation of Provisional Application No. 61/130,968, filed Jun. 5, 2008, and claims priority therefrom.

### BACKGROUND OF THE INVENTION

1. Field of the Invention

This invention relates to devices for implantation in the human body and, more particularly, to a dental implant device for providing therapeutic access to the medullary space of the maxillae and mandible in the human mouth in order to facilitate the deposition of therapeutic agents and the extraction of bone marrow contents.

When the device is bonded to the bony tissue of the jaw and the overlying tissues through which it is inserted, it will serve as a permanent indwelling device in like fashion to contemporary osseointegrated dental implants. As such, this device may be used ad libitum and ad infinitum for the injection of systemic and local therapeutic agents and the extraction or monitoring of components contained within the marrow space. Its hollow interior forms a port that is sealed and/or unsealed at will by a removable core. When sealed internally by its removable core, and sealed externally by its bonding to bone, it is impervious to microbial penetration and profoundly resistant to infection.

2. Description of the Related Art

Intraoral intraosseous drug delivery systems have been used for decades for the delivery of local anesthetic solutions to the medullary space proximate to areas undergoing dental treatment. Extraoral transdermal intraosseous devices have been used in recent times for emergency access to the systemic circulation; that is, intraosseous injection ports are in current use to gain access for emergency drug administration through the patella and sternum. Such extraoral intraosseous drug delivery systems as are known to create an unsealed pathway through the dermis, that makes it vulnerable to infection by dermalborne microbes. In hospitals and long-term clinical facilities, nosochomial microbes are extraordinary virulent and drug resistant. Long-term intraosseous ports (that are transdermal and extraoral) place patients at an increased risk for serious and sometimes lethal microbial disease from nosochomial sources. Current intraosseous drug-delivery systems of the prior art are thus useful for only limited time periods and are not sealed internally or bonded externally in order to prevent the ingress of locally invasive microbial disease which is proximate to these devices.

There are prior art devices which comprise an apparatus for intraosseous dental anesthesia and a method of use. Such apparatus, as known, has separate elements which require more time for installation. The threaded housing of the apparatus that is implanted into the patient is devoid of any sealing element, thereby limiting repeated use of the same device.

Typically, a prior art intraosseous infusion device uses an inclusion tube or needle having an enlarged threaded tip that is threaded into the bone of a patient. Such a device requires an operator for continuously monitoring the resistance between the device and the bone during threading. Moreover, the enlarged tip of the device damages the outer bone and leaves a hole in the outer bone that causes possible leakage of infused liquid.

Some of the conventional systems disclose an apparatus and a method for catheterized delivery or infusion of medication and anesthesia. Such apparatus fails to provide a prolonged access to medullary spaces. The repeated removal and insertion of such apparatus may result in nosochomial bacterial infections from dermal-borne microbes.

There is a definite need for a port that allows for injection of therapeutic agents into the medullary space and extraction of medullary space contents. The device of the invention may be permanently implanted in the patient's maxillae and/or mandible in a safe and effective manner. It is more resistant to infection than currently available intraosseous ports and therefore represents a novel system for long-term access to the bone marrow of the jaws for a multitude of purposes.

### SUMMARY OF THE INVENTION

In brief, one particular embodiment of the present invention is an orally implantable device called a TiPort™ (Titanium Port), which is analogous to contemporary dental implants. As such, it comprises a self-tapping screw fabricated of titanium, which is well-documented as having biocompatibility of long-term duration. Unlike dental implants that are intended to support prosthetic teeth, it features a novel hollowed internal design that will accommodate a conventionally sized hypodermic needle for injection or extraction of substances into and out of the marrow space of maxillae and mandibles.

An internal core is secured by internal threads that function in opposite direction to the external threads of this device. The hollowed interior, or “port”, is obturated by a multitude of core designs. One core type is designed for sealing only. A second core type incorporates a cutting tip that renders the entire device a self-tapping screw. This cutting tip is designed so as not to carry contents (which would normally accompany the implant) into the medullary space. A third core device is hollowed to allow for connection to a flexible external line and thus allow for fluid to traverse it to and from the external line.

One preferred embodiment of the invention comprises an implant housing component that is implanted into the cortical bone of the mandible. A drill bit component that produces a bore within the mandible (for initiating the implanting of the implant housing component), and a seal plug component that is removably mounted within the implant housing component allows for repeated access of a hypodermic needle into the mandible.

The implant housing component has an integrated tapered, self-tapping external thread that eliminates the risk and necessity of a separate step to tap threads into the cortical bone. The intraosseous injection of medication to the medullary cavity of a jawbone and the extraction of medullary bone contents are delivered through a chamfered channel within the implant housing component. The drill bit component has a hollow stylus with a sharpened tip at its distal end to drill the cortical bone of the mandible. The seal plug component (comprising a stylus with a flattened tip) has an external dimension that complements the internal dimension of the bore of the implant housing component.

The TiPort™ is implanted into the cortical bone of the mandible by placing the assembly of the implant housing component and the drill bit component on the cortical bone of the mandible. The implant housing component is installed into the mandible by rotating the assembly in a clockwise direction with a powered hand drill, using a drill bit with a socket head to engage the square head of the implant housing component.

The drill bit component within the bore of the implant housing component has a head with a slot, like a slotted screw, and it mates with internal left-hand threads in the bore of the implant housing component. After the implant housing component is seated in place, the drill may be fitted with a blade driver and the drill bit component removed from the left-hand threaded bore by rotating the drill bic component in a clockwise direction with a powered hand drill. Alternatively, a blade screwdriver may be used to remove the drill bit component. A Phillips-head or Allen-head screwdriver or other tool may be used as well. Thereafter a seal plug component is installed into the implant housing component by rotating the seal plug component in a counter-clockwise direction with a standard manual screwdriver.

Although the above description involves a right-hand external thread of the implant housing component, and the internal thread of the bore of this component involves a left-hand thread to accommodate the left-hand thread on the drill bit component, the orientation of the screw threads may be reversed, if desired, so that the external thread of the implant housing component is a left-hand thread, in which case the internal thread of the implant housing component and the external thread of the core would be right-handed. The important point is that these threads be opposite in direction to facilitate their manipulation into the mandible opening.

### DESCRIPTION OF THE DRAWINGS

Other features and advantages of the present invention will become apparent from the following detailed description, taken in conjunction with the accompanying drawings, in which:

FIG. 1A is a schematic view of the components of the preferred embodiment of the invention involved in the drilling and installation of the permanent implant housing component;

FIG. 1B is a schematic view of the same components shown in FIG. 1A, but from a different viewpoint;

FIG. 2 is a schematic view of the complete assembly of the components involved in the drilling and installation of the permanent implant housing component utilizing a powered hand drill common to the practice of dentistry;

FIG. 3A is a schematic view of the drilling and installation process of inserting the permanent implant housing component into the mandible, utilizing a powered hand drill;

FIG. 3B is a more detailed view of the drilling and installation process of inserting the permanent implant housing component into the mandible, showing the clockwise rotation to drive the implant housing component into the cortical bone of the mandible;

FIG. 3C shows the removal of the internal drill bit component utilizing a powered hand drill that provides a clockwise rotation with a screwdriver blade attachment, withdrawing the bit component by virtue of the left-hand threads within the bore of the implant housing component;

FIG. 3D is a schematic view showing the installation of the seal plug component that mates with the internal threads and sealing surfaces of the implant housing component. This seal plug component is installed using a counter-clockwise rotation provided by a standard manual screwdriver;

FIGS. 4A and 4B are two views of one particular version of the implant housing component;

FIGS. 5A and 5B are views of the drill component of the device of the invention;

FIGS. 6A and 6B are views of the seal plug component for insertion in the implant housing component;

FIG. 7 is a schematic view of intraosseous infusion utilizing a standard syringe;

FIG. 8 is a cross-sectional view of the assembly with the tip of the needle inserted in the hollow cavity of the implant housing component from which the seal plug has been removed. This hollow cavity features a tapered profile that forms a sealing surface with the end of the needle, as shown in FIG. 5;

FIG. 9A is an exploded view of a coupler used to connect an intravenous line to the implant housing component to provide intraosseous infusion to the mandible;

FIG. 9B is a schematic view of an assembly having the intravenous line connected;

FIG. 9C is a schematic view showing the assembly of FIG. 9B inserted in the mandible;

FIG. 10 is a schematic view showing intraosseous infusion to the mandible, utilizing an intravenous line attached to a 90° coupler;

FIG. 11A is an enlarged view of the assembly of the implant housing component and drill bit component used during the drilling and implant process;

FIG. 11B is a view of the same components of FIG. 11A, but from a different vantage point;

FIG. 12 is an enlarged view of the implant housing component;

FIG. 13 is a schematic view of the drill bit component;

FIG. 14 is a schematic view of the seal plug component;

FIG. 15 is an enlarged view of the assembly of the implant housing component and the seal plug component;

FIG. 16 is a sectional view illustrating the interrelationship of components involved during the drilling and installation of the implant assembly into the mandible;

FIG. 17A is a more detailed sectional view showing the drilling and installation of the implant housing component into the mandible by clockwise rotation (indicated by the arrow 27);

FIG. 17B is a more detailed sectional view showing the removal of the drill bit component, also clockwise, from the installed implant housing component;

FIG. 17C is a more detailed sectional view showing the installation of the protective seal plug component (driven counter-clockwise) into the installed implant housing component;

FIG. 17D is a detailed sectional view showing an intravenous line connected to the installed implant housing assembly for intraosseous infusion into the mandible;

FIG. 18A is a schematic view of an alternative design of the drill component and its matching drive socket that provides for increased stability during the process of drilling and installing the implant housing component;

FIG. 18B is a schematic view of the drill bit component of FIG. 18A prior to the completion of the installation of the implant housing component; and

FIG. 19 is an enlarged sectional view showing the relationship of the drill component of FIGS. 18A and 18B and its matching drive socket during the process of installing the implant housing component into the mandible.

### DETAILED DESCRIPTION OF THE PREFERRED EMBODIMENTS

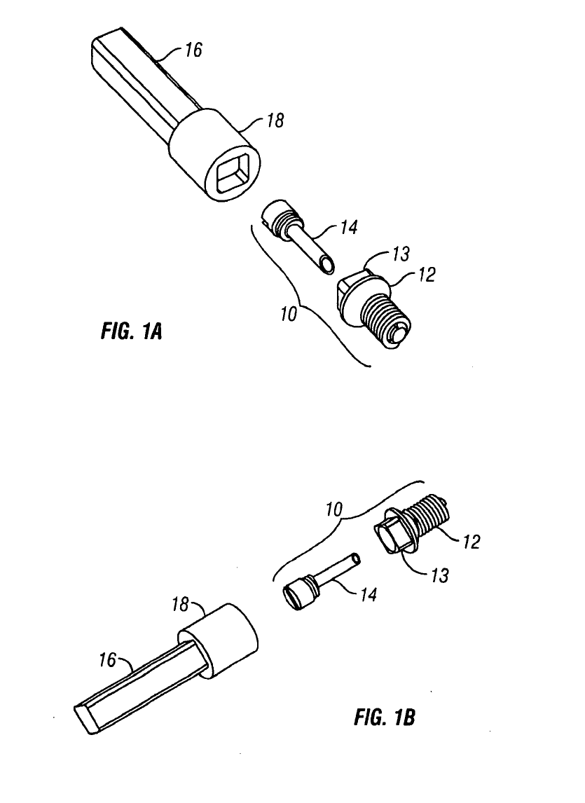

FIGS. 1A and 1B are exploded views of a device 10 in accordance with the invention for intraosseous injection of medication to the medullary cavity of a jawbone (not shown) and the extraction of medullary bone contents. The device 10 includes an implant housing component 12, a drill bit component 14 which is installed into the implant housing component 12, and a drill driver 16 with a socket 18 to mate with the head 13 of the implant housing component 12.

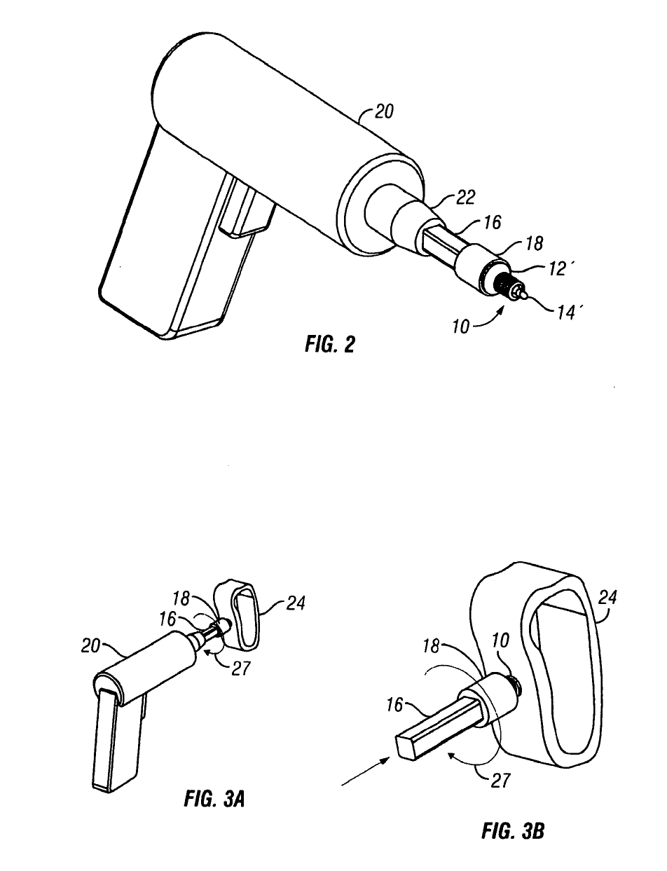

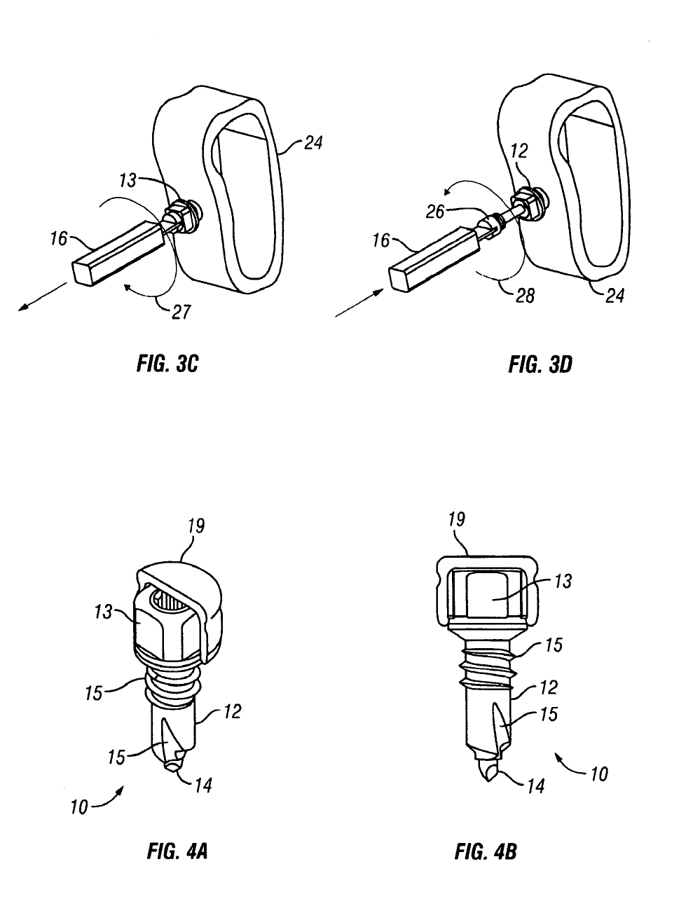

FIG. 2 shows the assembled device 10 coupled to the socket 18 of the driver 16 which is installed in the chuck 22 of a powered hand drill 20. The hand drill 20 initiates the drilling and installation of the device 10 into the mandible 24 (FIGS. 3A and 3B).

The implant housing component 12 is hollow with a bore region that is threaded with left-hand thread 13 to receive the drill bit component 14 which is also provided with a left-hand thread. As combined to establish the device 10, the device 10 is shown in FIGS. 3A and 3B as having been driven by the drill 20 into the mandible 24.

The drill bit component 14 within the implant housing component 12 is driven into the cortical bone of mandible 24 by the drill 20 and establishes a hole by virtue of the self-tapping threads 15 of the implant housing component 12. In the driving of the device 10 into the mandible 24, the assembly 10 is rotated in a clockwise direction and a powered hand drill 20 is utilized for its insertion.

FIGS. 3C and 3D show the use of a driver 16, which may either be used as a hand implement or within the chuck 22 of the drill 20 to, first, remove the drill component 14 from the implant housing component 12 by driving it in the clockwise direction (FIG. 3C); and then, using the same blade driver, rotate it in a counter-clockwise direction (FIG. 3D) to insert a threaded seal plug 26 into the implant housing component 12.

The elements comprising the device 10 of the present embodiment of invention are shown in further detail in FIGS. 4A-6B.

FIGS. 4A and 4B show the device assembly 10 including the drill component 14 within the implant housing component 12 which has self-tapping threads 15 and a square head 13 for engaging the socket 18 of the driver 16. As shown in FIGS. 4A and 4B, the head 13 is covered by a removable cap 19.

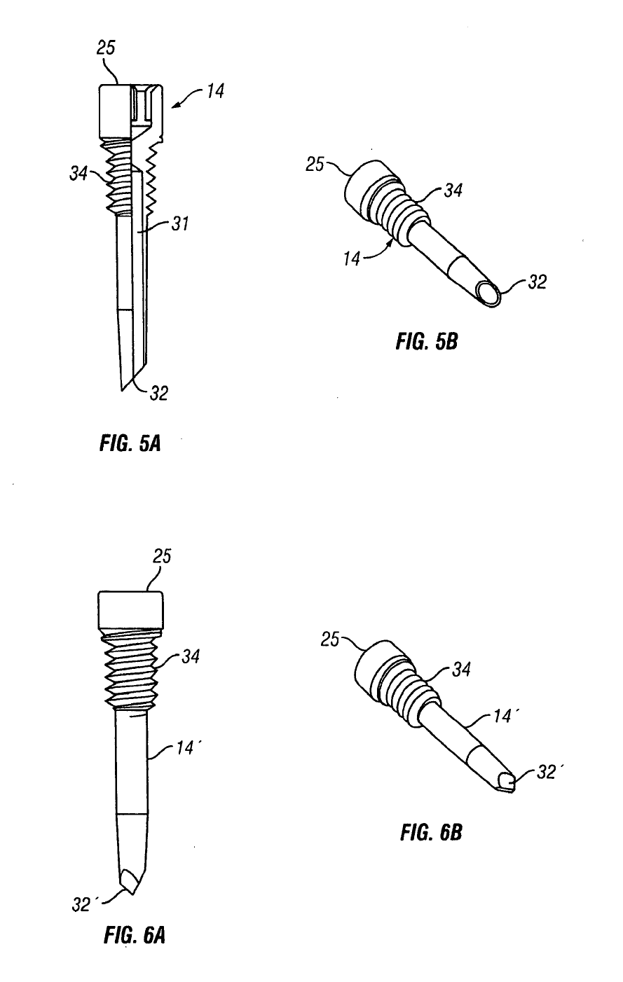

FIGS. 5A and 5B portray the drill component as having a hollow center 31 terminating in a beveled tip 32.

FIGS. 6A and 6B show a variant of the drill component labeled 14′ which has a double-beveled tip 32′.

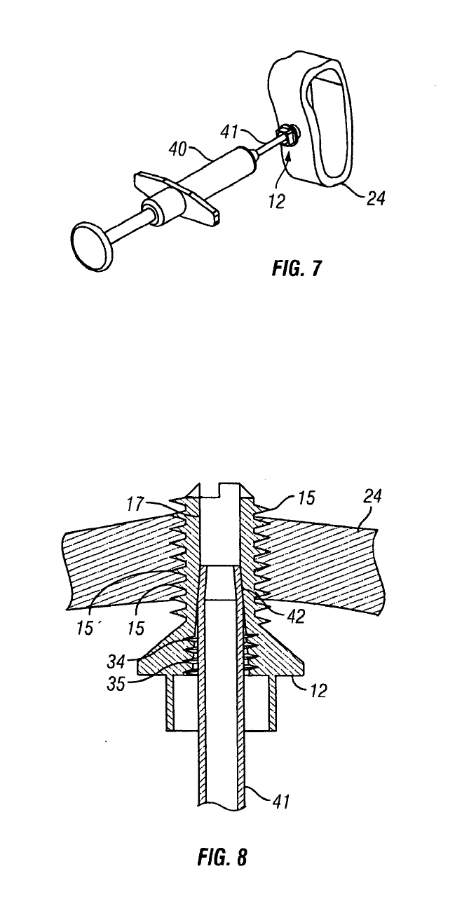

FIG. 7 shows a hypodermic syringe 40 coupled to the implant housing component 12 for the intraosseous injection of medication to the medullary cavity of the jawbone 24 and also the extraction of medullary bone contents by way of the device 12. This is better shown in the enlarged cross-sectional view of FIG. 8 wherein the needle 41 is inserted into the bore 17 of the implant housing component 12. This bore 17 is a chamfered channel with a tapered profile that forms a sealing surface with the needle 41. The needle 41 is also tapered at its tip 42 to enhance the sealing capability of the two adjacent surfaces.

The sectional view of FIG. 8 also shows the external self-tapping threads 15 of the implant housing component 12 and the internal self-tapped threads 15′ in the mandible 24.

As part of the system of the invention, provision is made for the coupling of an intravenous line 56 into the implant housing component 12.

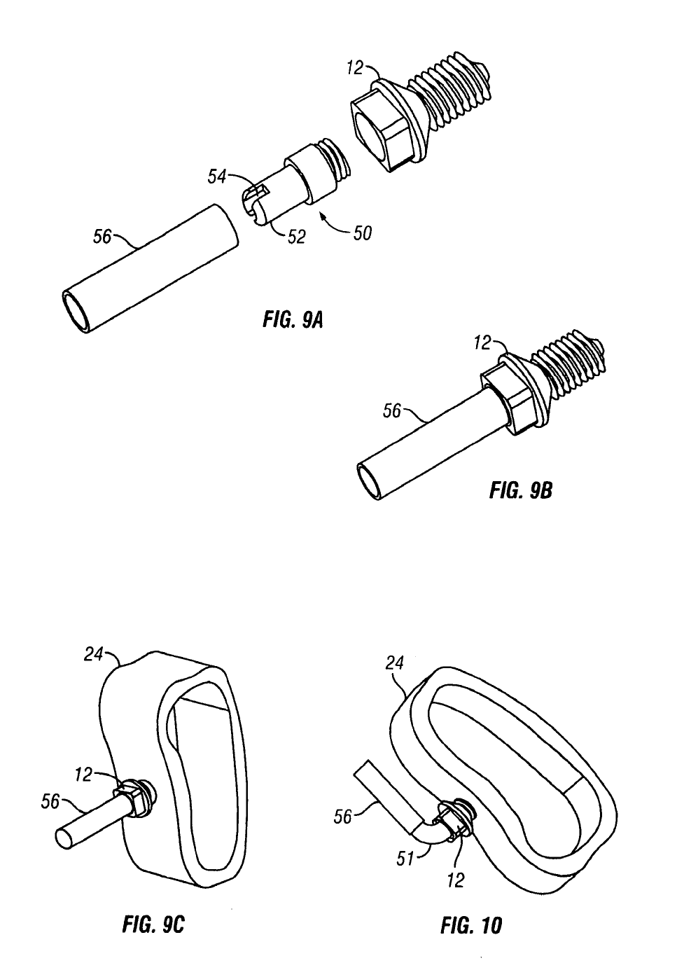

This is shown in FIGS. 9A and 9B as including a hollow coupler 50, having a recessed surface 52 and a slotted end 54 for receiving one end of the intravenous line 56. These are shown in assembled form in FIG. 9B. FIG. 9C shows the assembly of FIG. 9B connected to the mandible 24.

FIG. 10 shows a coupler 51 connecting the intravenous line 56 with the implant housing component 12 through a 90° elbow attachment. This arrangement facilitates the delivery of medication and extraction of fluids from the medullary cavity for a longer duration, such as when lying flat on the bed.

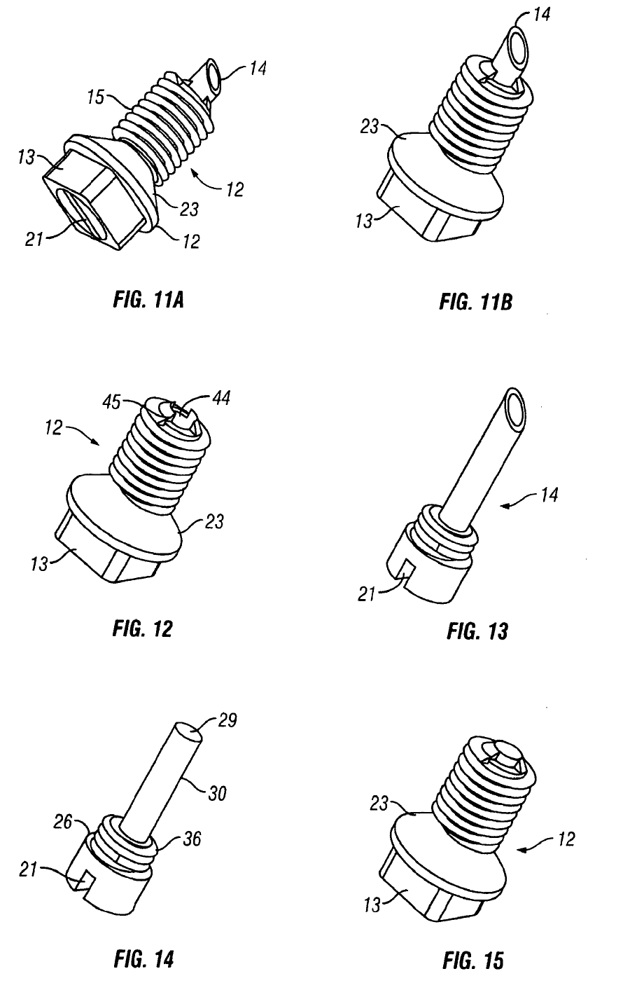

FIGS. 11A and 11B show schematic views of the assembly of the implant housing component 12 and the drill bit component 14. The square drive head 13 at the proximal end of the implant housing component 12 allows for torque transfer to the sealing surface 23 of the implant housing component 12. The square drive head 13 is engaged with at least one of a powered hand drill 20 and/or a hand wrench (not shown) to drive the implant housing component 12 into the cortical bone of the mandible 24.

FIG. 12 shows a schematic view of the implant housing component 12 having a cylindrical bore 44 that allows for the insertion of the drill bit component 14.

FIG. 13 shows a schematic view of the drill bit component 14 as shown in FIG. 5A. The drill bit component 14 produces a bore 17 within the mandible 24 for initiating the implanting of the implant housing component 12.

FIG. 14 shows a schematic view of a seal plug component 26 having a stylus 30 with a flattened end 29 and an external thread 36 that matches the internal threads of the implant housing component 12, and a head 13 with a screwdriver slot 21.

FIG. 15 shows a schematic view of the assembly of an implant housing component 12 and a seal plug component 26 with flattened end 29 that is removably mounted within the implant housing component 12. Removal of the plug 26 allows repeated access of a hypodermic needle 41 into the mandible 24.

FIG. 16 shows a cross-sectional view of the drilling and installation process of the implant housing component 12 into the mandible 24, using the drill driver 16 and socket 18.

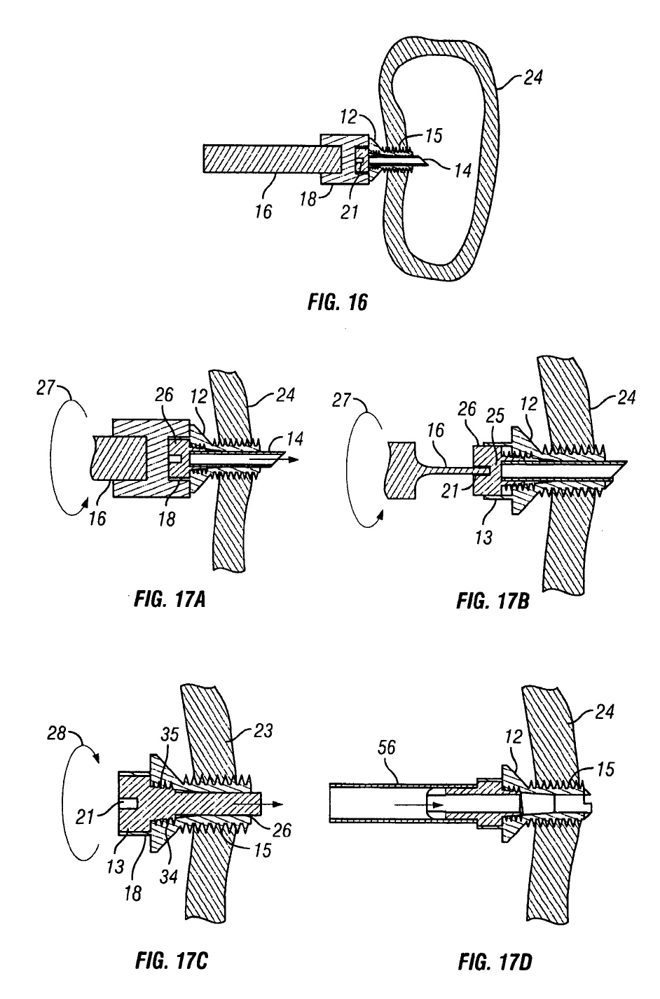

FIGS. 17A and 17B show the cross-sectional view of the removal process of the drill bit component 14 from the installed implant housing component 12, using a bladed driver 16.

FIG. 17C is a cross-sectional view of the installation of the seal plug component 26 into the installed implant housing component 12. The external threaded portion 35 of the seal plug component 26 is accommodated in the internal threaded portion 34 of the implant housing component 12.

FIG. 17D is a cross-sectional view showing the intraosseous infusion by way of the intravenous line 56 and coupler 50 threaded into the implant housing component 12 which is driven into the cortical bone of the mandible 24.

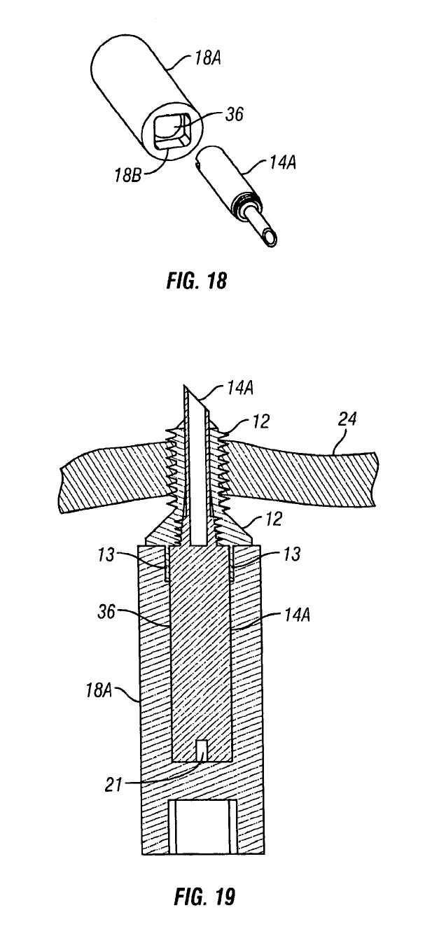

FIG. 18 is a schematic view with an alternate design of the drive socket 18 and drill component. The head of the drill component is substantially longer in this design and a matching deep socket (FIGS. 18A, B) with matching deeper receptacle 36 is used for improved stability.

FIG. 19 is a detailed sectional view showing the interrelationship of the alternative design of the drill bit component 14A and its matching drive socket 18A during the drilling and installation process of the implant housing component 12 into the mandible 24.

In summary, the device of the invention is an improved permanent dental implant that allows virtually instantaneous access to the medullary cavity in the human jaw with a reduced risk of nosochomial bacterial infection.

Although there have been described hereinabove various specific arrangements of a TiPort™ in accordance with the invention for the purpose of illustrating the manner in which the preferred embodiment of the invention may be used to advantage, it will be appreciated that the invention is not limited thereto. Accordingly, any and all modifications, variations or equivalent arrangements which may occur to those skilled in the art should be considered to be within the scope of the invention as defined in the annexed claims.

1. Apparatus for use in moving fluid to or from a human jawbone, comprising:
an implant housing component having a central threaded bore into which is threaded a drill component for opening a hole in the mandible;
said implant housing component having an outer surface supporting screw threads of the self-tapping type, angled to propel the implant housing component forward into the mandible when rotated in a first direction,
the internal threads of said bore and the mating external threads of said drill component being angled for propulsion in a second direction opposite to said first direction; and
a threaded seal plug mounted in place of the drill component in said bore when the implant housing component is implanted into the jawbone.

2. The apparatus of claim 1 wherein the self-tapping threads of the implant housing component outer surface are of the right-hand thread type.

3. The apparatus of claim 2 wherein the internal threads of said bore and the external threads of said drill component are of the left-hand thread type.

4. The apparatus of claim 1 wherein said seal plug is provided with external threads to mate with the internal threads of said bore.

5. The apparatus of claim 1 wherein said drill component has a pointed tip which projects beyond the implant housing component to initiate opening a hole in the mandible.

6. The apparatus of claim 5 wherein the tip of said drill component is hollow and is beveled to form a point.

7. The apparatus of claim 5 wherein said drill component tip has a double bevel to form its point.

8. The apparatus of claim 4 wherein the external threads of the removable seal plug are oriented in a direction to mate with the internal threads of said bore.

9. The apparatus of claim 1 further including a syringe having a hypodermic needle for mating within said bore of the implant housing component and in place of the removable seal plug, for driving fluid into the marrow region of the mandible.

10. The apparatus of claim 9 wherein fluid is also withdrawn from the mandible.

11. The apparatus of claim 1 wherein said implant housing component has a head which is shaped to be engaged by a tool to drive the implant housing component in a clockwise direction.

12. The apparatus of the claim 8 wherein said drill component has a head containing a slot for engagement with a blade screwdriver for driving said drill component into or out of said bore.

13. The apparatus of the claim 8 wherein said drill component has a head for means of engagement with a powered driving tool to propel said drill component in forward or rearward motion within said bore.

14. A TiPort for intraosseous injection of medication to the medullary cavity of a jawbone and the extraction of medullary bone contents, comprising:
an implant housing component that is implanted into the cortical bone of the mandible;
a drill bit component that produces a bore within the mandible for initiating the implanting of the implant housing component; and
a seal plug component that is removably inserted into the distal end of the implant housing component which allows for repeated access of a hypodermic needle into the mandible.

15. A method for transferring fluid to the marrow region of a human jawbone in which the assembly of a seal plug installed within the central bore of an implant housing component which has been implanted into the jawbone, comprising the steps of:
withdrawing the seal plug from the bore of the implant housing component; and
placing the hypodermic needle of a hypodermic syringe into the bore from which the seal plug has been removed to insert medication;

16. The method of claim 15 including the step of manipulating the syringe to withdraw fluids out of the marrow region of the jawbone.

17. The method of claim 16 further including the step of withdrawing the needle and reinserting the seal plug to seal the opening of the permanently implanted implant housing component.
